(19) United States
(12) Patent Application Publication
(10) Pub. No.: US 2023/0112150 A1
(43) Pub. Date: Apr. 13, 2023

(54) METHOD FOR DETERMINING PRINT PATH, PROGRAM FOR EXECUTING METHOD FOR DETERMINING PRINT PATH AND PRINTING METHOD

(71) Applicant: SEMES CO., LTD., Cheonan-si (KR)

(72) Inventors: Min Ho PARK, Daejeon (KR); Ye Chan JEONG, Siheung-si (KR)

(73) Assignee: SEMES CO., LTD., Cheonan-si (KR)

(21) Appl. No.: 17/956,099

(22) Filed: Sep. 29, 2022

(30) Foreign Application Priority Data
Sep. 30, 2021 (KR) 10-2021-0129511
Sep. 5, 2022 (KR) 10-2022-0112361

(51) Int. Cl. B41J 2/045

(52) U.S. Cl. CPC B41J 2/04536; B41J 2/04586

(57) ABSTRACT

Provided is a method for determining print paths to be applied when ink is ejected to a substrate. The method for determining the print paths includes a substrate information receiving step of receiving substrate information of the substrate, a head information receiving step of receiving head information of a head that ejects the ink, and a print path determining step of determining the print paths based on the substrate information and the head information, in which in the print path determining step, the smallest number of print paths satisfying a target printing condition for the substrate may be determined.

### CROSS-REFERENCE TO RELATED APPLICATIONS

This application claims priority to and the benefit of the Korean Patent Application No. 10-2021-0129511 filed in the Korean Intellectual Property Office on Sep. 30, 2021 and the Korean Patent Application No. 10-2022-0112361 filed in the Korean Intellectual Property Office on Sep. 05, 2022 the entire contents of which are incorporated herein by reference.

### TECHNICAL FIELD

The present invention relates to a method for determining a print path to be applied to an inkjet printing process, a program stored in a medium for executing the method for determining the print path, and a printing method.

### BACKGROUND ART

Recently, display devices such as a liquid crystal display devices and an organic EL display devices have required a high resolution. In order to manufacture a display device having a high resolution, it is necessary to form more pixels per unit area on a substrate, and in a display device manufacturing process, it is important to accurately eject ink to each of the pixels that are densely disposed. As a precision requirement level in the display device manufacturing process increases, a display device manufacturing time increases. As a result, the number of display devices that can be manufactured per unit time is reduced.

Meanwhile, a process (so-called, a printing process) of ejecting ink to each of the pixels described above is performed by an inkjet device that ejects ink in the form of droplets. The inkjet device includes a head, and the head has nozzles that eject the ink. When the position of the head is determined, glass as an object on which ink is ejected is moved to a lower region of the head. The glass passes through the lower region of the head while the ink is ejected from the nozzles of the head.

In addition, the glass consists of pixels, which are a plurality of print units. Each pixel has an amount of required droplets to complete the printing process. The amounts of required droplets may vary. Therefore, in the printing process, while the glass passes through the lower region of the head, the head ejects the ink to satisfy the amount of droplets required by each pixel. The amount of liquid crystal ejected by the head is smaller than or equal to the amount of liquid crystal required by the pixel. Accordingly, the printing process cannot be completed when the glass passes through the lower region of the head once. When the glass passed through the lower region of the head, the position of the head is changed (that is, a print path is continuously changed), and when the glass passes through the lower region of the head again, the printing process is completed by repeating the process of ejecting the ink onto the glass multiple times. In other words, in order to complete the printing process, a plurality of print paths needs to be applied.

In general, the print path to be applied to the printing process is implemented by moving the position of the head sequentially at specific intervals. For example, when the head is located in a first position during first printing, the glass passes through the lower region of the head. Thereafter, the head is located in a second position by moving by a predetermined distance from the first position. In addition, the glass passes through the lower region of the head again. Thereafter, the head is located in a third position by moving by a predetermined distance from the second position. In addition, the glass passes through the lower region of the head again. However, the selecting of the print path to be applied to the printing process in the same manner may be performed by repeating unnecessary printing.

### SUMMARY OF THE INVENTION

The present invention has been made in an effort to provide a method for determining a print path capable of effectively treating a substrate, a program for executing the method for determining the print path, and a printing method.

The present invention has also been made in an effort to provide a method for determining a print path capable of effectively shortening a time required to complete a printing process, a program for executing the method for determining the print path, and a printing method.

The present invention has also been made in an effort to provide a method for determining a print path capable of satisfying a target printing condition for a substrate through the smallest number of print paths, a program for executing the method for determining the print path, and a printing method.

The problem to be solved by the present invention is not limited to the above-mentioned problems, and the problems not mentioned will be clearly understood by those skilled in the art from the present specification and the accompanying drawings.

An exemplary embodiment of the present invention provides a method for determining print paths to be applied when ink is ejected to a substrate. The method for determining the print paths includes a substrate information receiving step of receiving substrate information of the substrate; a head information receiving step of receiving head information of a head that ejects the ink; and a print path determining step of determining the print paths based on the substrate information and the head information, in which in the print path determining step, the smallest number of print paths satisfying a target printing condition for the substrate may be determined.

In the exemplary embodiment, the print path determining step may include a virtual substrate generation step of generating a virtual substrate reflecting the target printing condition based on the substrate information; a print path selection step of selecting a print path having a high priority from the print paths; a simulation step of performing virtual printing by applying the selected print path to the virtual substrate; and a confirmation step of confirming whether the target printing condition has been satisfied, after the simulation step.

In the exemplary embodiment, the substrate information may include information on a position of a print unit in which the ink is ejected to the substrate and a target ejection ink amount required for the print unit, and in the print path selection step, a print path far from a central portion of a print region may be preferentially selected from the print paths, wherein the print region may consist of the print units.

In the exemplary embodiment, in the print path determining step, a print path which is less overlapped with a region to which the virtual printing is applied or a region in which the virtual printing is completed may be preferentially selected from the print paths.

In the exemplary embodiment, the head information may include nozzle grade information about a grade of each of the nozzles based on at least one of impact reproducibility of each of the nozzles of the head, the number of times of use of each of the nozzles, and uniformity of the amount of ink to be ejected from each of the nozzles; or position information of usable nozzles among the nozzles of the head and nozzle specification information on the amount of the ink to be ejected from each of the nozzles.

In the exemplary embodiment, in the print path determining step, a print path including more nozzles of a high grade may be preferentially selecting from the print paths.

In the exemplary embodiment, in the print path determining step, a print path including more usable nozzles overlapped with a region required for printing may be preferentially selecting from the print paths.

In the exemplary embodiment, the virtual substrate may be expressed in the form of a grid.

In the exemplary embodiment, in the virtual substrate generation step, the virtual substrate may be generated as many as the number of colors of the ink.

In the exemplary embodiment, in the virtual substrate generation step, a target ejection ink amount or the number of target ejection ink droplets may not be applied to the virtual substrate, and in the simulation step, the virtual printing on the virtual substrate may be performed in an up-counting manner.

In the exemplary embodiment, in the virtual substrate generation step, the target ejection ink amount or the number of target ejection ink droplets may be applied to the virtual substrate, and in the simulation step, the virtual printing on the virtual substrate may be performed in a down-counting manner.

Another exemplary embodiment of the present invention provides a program stored in a medium for executing the method for determining the print paths.

Yet another exemplary embodiment of the present invention provides a printing method for ejecting ink to a substrate using a head. The printing method may include a virtual printing step for determining print paths to be applied when ink is ejected the substrate; and an actual printing step of ejecting the ink to the substrate based on the print paths determined in the virtual printing step, in which in the virtual printing step, the smallest number of print paths satisfying a target printing condition for the substrate may be determined.

In the exemplary embodiment, the virtual printing step may include a virtual substrate generation step of generating a virtual substrate reflecting the target printing condition based on substrate information of the substrate, wherein the substrate information includes information about a position of a print unit in which the ink is ejected to the substrate and a target ejection ink amount required for the print unit; a print path selection step of selecting a print path having a high priority from the print paths; a simulation step of performing virtual printing by applying the selected print path to the virtual substrate; and a confirmation step of confirming whether the target printing condition has been satisfied, after the simulation step.

In the exemplary embodiment, when the target printing condition is not satisfied in the confirmation step, the print path selection step may be additionally performed, and when the target printing condition is satisfied in the confirmation step, the actual printing step is performed using selected print paths until the target printing condition may be satisfied.

In the exemplary embodiment, in the print path selection step, the print path may be selected according to the priority based on at least one of a) a position of a print path; b) the number of nozzles of the head passing through a region required for printing; and c) a grade of the nozzle.

In the exemplary embodiment, with respect to a) above, the priority of the print path which is far from the central region of the print region required for printing of the substrate may be higher among the print paths.

In the exemplary embodiment, with respect to b) above, the priority of the print path which has a large number of nozzles passing through the region required for printing may be higher among the print paths.

In the exemplary embodiment, with respect to c) above, the grade of the nozzle may be determined based on reproducibility of the ink impact position of the nozzles, the number of times of use of the nozzles, uniformity of the amount of ink to be ejected from the nozzles, and the amount of ink to be ejected from the nozzles.

In the exemplary embodiment, the virtual substrate may be expressed in the form of a grid, but when a moving direction of the substrate is referred to as a second direction and a moving direction of the head is referred to as a first direction, when the arrangement of the print units located at the outermost side among the print units is parallel to the first direction and the second direction, the virtual substrate may be expressed by grids arranged in the first direction and lengths in the second direction, and when the arrangement of the print units located at the outermost side among the print units is not parallel to the first direction or the second direction, the virtual substrate may be expressed only by the grids.

According to an exemplary embodiment of the present invention, it is possible to effectively treat a substrate.

In addition, according to an exemplary embodiment of the present invention, it is possible to effectively shorten a time required to complete a printing process.

In addition, according to an exemplary embodiment of the present invention, it is possible to satisfy a target printing condition for a substrate through the smallest number of print paths.

The effect of the present invention is not limited to the foregoing effects, and non-mentioned effects will be clearly understood by those skilled in the art from the present specification and the accompanying drawings.

### BRIEF DESCRIPTION OF THE DRAWINGS

FIG. 1 is a diagram schematically illustrating an inkjet system according to an exemplary embodiment of the present invention.

FIG. 2 is a diagram schematically illustrating an example of an actual substrate, which is an object to be treated, on which the inkjet system of FIG. 1 performs a printing process.

FIG. 3 is a flowchart illustrating a printing method according to an exemplary embodiment of the present invention.

FIG. 4 is a diagram schematically illustrating an appearance of an inkjet device that performs an ejecting operation.

FIG. 5 is a diagram schematically illustrating an appearance of the inkjet device that performs a path changing operation.

FIG. 6 is a diagram schematically illustrating an appearance of the inkjet device that performs the ejecting operation again, after the path changing operation of FIG. 5.

FIG. 7 is a flowchart illustrating a virtual printing step of FIG. 3.

FIG. 8 is a diagram illustrating an example of a virtual substrate generated in a virtual substrate generation step of FIG. 7.

FIG. 9 is a diagram illustrating another example of the virtual substrate generated in the virtual substrate generation step of FIG. 7.

FIG. 10 is a diagram schematically illustrating another example of the actual substrate, which is the object to be treated, on which the inkjet system of FIG. 1 performs a printing process.

FIG. 11 is a diagram illustrating another example of the virtual substrate generated in the virtual substrate generation step of FIG. 7.

FIG. 12 is a diagram illustrating another example of the virtual substrate generated in the virtual substrate generation step of FIG. 7.

FIG. 13 is a diagram illustrating an example of print paths that may be applied during a printing process for the virtual substrate in relation to a print path selection step of FIG. 7.

FIG. 14 is a diagram illustrating another example of the print paths that may be applied during the printing process for the virtual substrate in relation to the print path selection step of FIG. 7.

FIGS. 15 to 17 are diagrams illustrating examples of weight functions that may be applied in relation to the print path selection step of FIG. 7.

FIG. 18 is a diagram for describing selecting a print path by considering a region to which the printing is applied or a region in which the printing is completed, in relation to the print path selection step of FIG. 7.

FIG. 19 is a diagram for describing selecting a print path by additionally considering the number of usable nozzles of a head in addition to the consideration of the region to which the printing is applied or the region in which the printing is completed, in relation to the print path selection step of FIG. 7.

FIG. 20 is a diagram illustrating an example of a virtual substrate, before a simulation step is performed.

FIG. 21 is a diagram illustrating an appearance of the virtual substrate of FIG. 20 after the simulation step is performed.

FIG. 22 is a diagram illustrating another example of the virtual substrate, before the simulation step is performed.

FIG. 23 is a diagram illustrating an appearance of the virtual substrate of FIG. 22 after the simulation step is performed.

### DETAILED DESCRIPTION

Hereinafter, an exemplary embodiment of the present invention will be described more fully hereinafter with reference to the accompanying drawings, in which exemplary embodiments of the invention are shown. However, the present invention can be variously implemented and is not limited to the following exemplary embodiments. In the following description of the present invention, a detailed description of known functions and configurations incorporated herein is omitted to avoid making the subject matter of the present invention unclear. In addition, the same reference numerals are used throughout the drawings for parts having similar functions and actions.

Unless explicitly described to the contrary, the term of “including” any component will be understood to imply the inclusion of stated elements but not the exclusion of any other elements. It will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

The singular expression includes the plural expression unless the context clearly dictates otherwise. Accordingly, shapes, sizes, and the like of the elements in the drawing may be exaggerated for clearer description.

Terms, such as first and second, are used for describing various constituent elements, but the constituent elements are not limited by the terms. The terms are used only for distinguishing one component from the other component. For example, without departing from the scope of the invention, a first constituent element may be named as a second constituent element, and similarly a second constituent element may be named as a first constituent element.

All terms used herein including technical or scientific terms have the same meanings as meanings which are generally understood by those skilled in the art unless they are differently defined. Terms defined in generally used dictionary shall be construed that they have meanings matching those in the context of a related art, and shall not be construed in ideal or excessively formal meanings unless they are clearly defined in the present application.

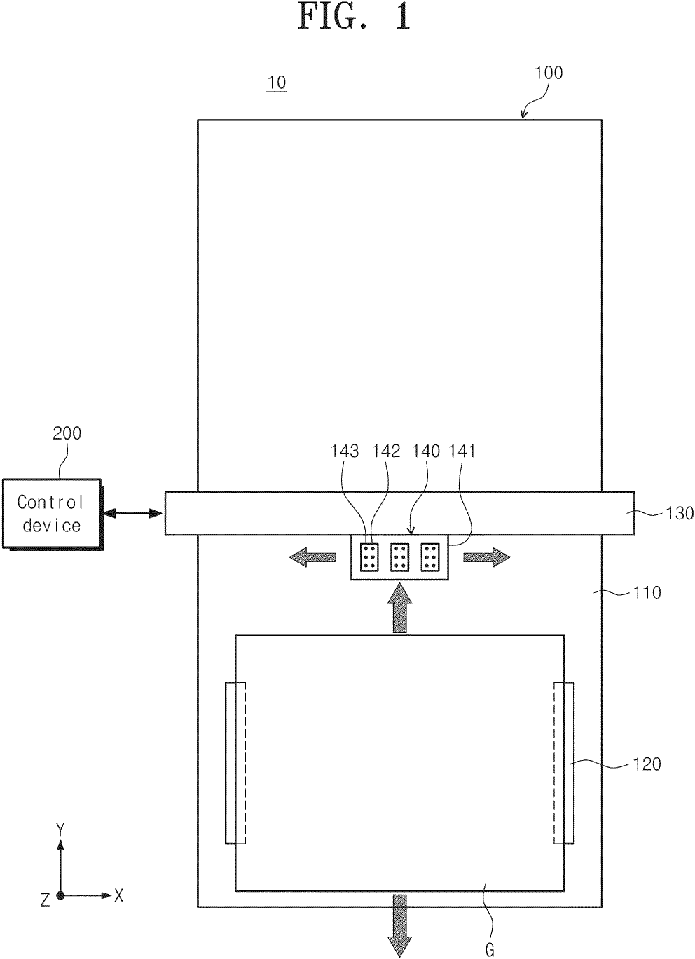

Hereinafter, an exemplary embodiment of the present invention will be described with reference to FIGS. 1 to 23.

A substrate G, which is an object to be treated by an inkjet system 10 to be described below, will be described as an example of glass. The substrate G may mean an actual substrate on which the printing process is actually performed.

FIG. 1 is a diagram schematically illustrating an inkjet system according to an exemplary embodiment of the present invention. FIG. 1 illustrates a plane (an appearance viewed from the top to the bottom) of an inkjet device 100. Hereinafter, a direction parallel to a moving direction of the substrate G is referred to as a second direction Y, and a direction perpendicular to the second direction Y when the inkjet device 100 is viewed from a plane may be defined in a first direction X. The first direction X may be a direction parallel to the moving direction of a head unit 140. In addition, a direction parallel to the first direction X and the second direction Y may be defined as a third direction Z. The third direction Z may be a direction perpendicular to the ground.

Referring to FIG. 1, the inkjet system 10 according to an exemplary embodiment of the present invention may include the inkjet device 100 and a control device 200. The inkjet device 100 may be configured to perform a printing process of ejecting ink to the substrate G. The control device 200 may control the driving of the inkjet device 100.

The inkjet device 100 may include a stage 110, a moving unit 120, a gantry unit 130, and a head unit 140.

The stage 110 may provide a region in which a printing process for the substrate G is performed. The stage 110 may provide a region in which the substrate G is loaded or unloaded. A lower surface of the substrate G may be disposed in contact with the stage 110. Unlike this, gas injection holes (not illustrated) may be formed in the stage 110 to float the substrate G by injecting gas to the lower surface of the substrate G. The gas injection holes (not shown) that may be formed in the stage 110 may inject inert gas such as nitrogen to the lower surface of the substrate G to float the substrate G to a predetermined height.

The moving unit 120 may move the substrate G. When the gas injection holes are formed in the stage 110 to inject the gas to the lower surface of the substrate G, the moving unit 120 may grip the substrate G. The moving unit 120 may grip the substrate G to locate the substrate G at a predetermined height. In addition, the moving unit 120 may include a grip hand for gripping the substrate G, and a traveling rail (not illustrating) for moving the grip hand along the second direction Y. The moving unit 120 may be configured to move the substrate G along the second direction Y while gripping one side and the other side of the lower surface of the substrate G. The moving unit 120 may move the substrate G forward or backward in the second direction Y.

In the above-described example, the moving unit 120 includes the grip hand and the traveling rail, and it has been described as an example that the grip hand grips one side and the other side of the lower surface of the substrate G, but is not limited thereto. For example, the moving unit 120 may include a support plate having a seating surface on which the substrate G may be disposed, and a traveling rail for moving the support plate.

The gantry unit 130 may provide a movement path through which the head unit 140 to be described below moves. The gantry unit 130 may include a body and a driving member (e.g., a motor and the like, not illustrated) for changing the position of the head unit 140. The body may have a shape extending from both sides of the stage 110 in the third direction Z and extending across the stage 110 in the first direction X.

The head unit 140 may eject the ink to the substrate G to perform the printing process. The head unit 140 may include a frame 141 and a head 142. The frame 141 of the head unit 140 is installed on the body of the gantry unit 130 to move along the first direction X. In addition, a plurality of insertion spaces into which the head 142 may be inserted may be formed in the frame 141.

A plurality of heads 142 may be provided. A plurality of nozzles 143 for ejecting ink in the form of droplets may be formed in each head 142. The plurality of nozzles 143 may eject different volumes of ink. For example, among the nozzles 143, the nozzles 143 belonging to a first group are configured to eject a first volume of ink, and among the nozzles 143, the nozzles 143 belonging to a second group different from the first group may be configured to eject the ink of a second volume different from the first volume. The expression of the different volumes from each other may be used as the same or similar meaning to the expression that the amounts of ink are different from each other or diameters of ink in the droplet form are different from each other.

In FIG. 1, it has been illustrated as an example that three insertion spaces are formed in the frame 141, three heads 142 are provided, and six nozzles 143 are formed in each head 142. This is just one example, and the number of insertion spaces formed in the frame 141, the number of heads 142, and the number of nozzles 143 formed in the head 142 may be variously modified according to the needs of the user.

The control device 200 may control the operation of the inkjet device 100. The control device 200 may generate a control signal for controlling the operation of the inkjet device 100. The control device 200 may be configured to perform a virtual printing step (S10) to be described below. In addition, the control device 200 may generate a control signal so that the inkjet device 100 may actually perform an actual printing step (S20). In addition, the control device 200 may include a process controller consisting of a microprocessor (computer) executing a control of the inkjet device 100, a user interface consisting of a keyboard for performing a command input operation and the like to allow an operator to manage the inkjet device 100, a display for visualizing and displaying an operating situation of the inkjet device 100, and the like, and a storage unit stored with control programs for executing the actual printing step (S20) performed by the inkjet device 100 under the control of the process controller, or programs for executing processing in each component according to various data and processing conditions. The control device 200 may include a storage medium for storing a program for performing the virtual printing step (S10) to be described below. The storage medium may be a hard disk, and may also be a portable disk such as a CD-ROM or a DVD, or a semiconductor memory such as a flash memory.

FIG. 2 is a diagram schematically illustrating an example of an actual substrate, which is an object to be treated, on which the inkjet system of FIG. 1 performs a printing process.

Referring to FIG. 2, the substrate G, which is an object to be treated, on which the inkjet system 10 according to an exemplary embodiment of the present invention performs the printing process, may be glass having a substantially rectangular shape. The substrate G may be an actual substrate that is an object to be treated in the actual printing step (S20).

The substrate G may include a print region SP that is a region from which the ink is to be ejected and a non-print region NP that is a region other than the print region SP and a region from which the ink is not ejected. In addition, the print region SP included in the substrate G may include a plurality of print regions SP1, SP2, SP3, and SP4. For example, the print region SP may include a first print region SP1, a second print region SP2, a third print region SP3, and a fourth print region SP4. The print region SP may be formed of a plurality of print units. The print unit may be one pixel formed on the substrate G. One print unit may include a plurality of auxiliary print units. The auxiliary print unit may be a sub pixel that may be included in one pixel. One print unit may include red, green, and blue elements. One auxiliary print unit may include any one of red, green, and blue elements. A shape, a size, a position, and a target ejection ink amount (which may also be referred to as a target volume) of the print unit may vary depending on a type of the substrate G to be processed or a specification of the display device to be manufactured. In addition, as at least one ejecting operation through the nozzles 143 of the head unit 140 or a plurality of ejecting operations through one nozzle are performed with respect to the print unit, the target ejection ink amount described above may be satisfied.

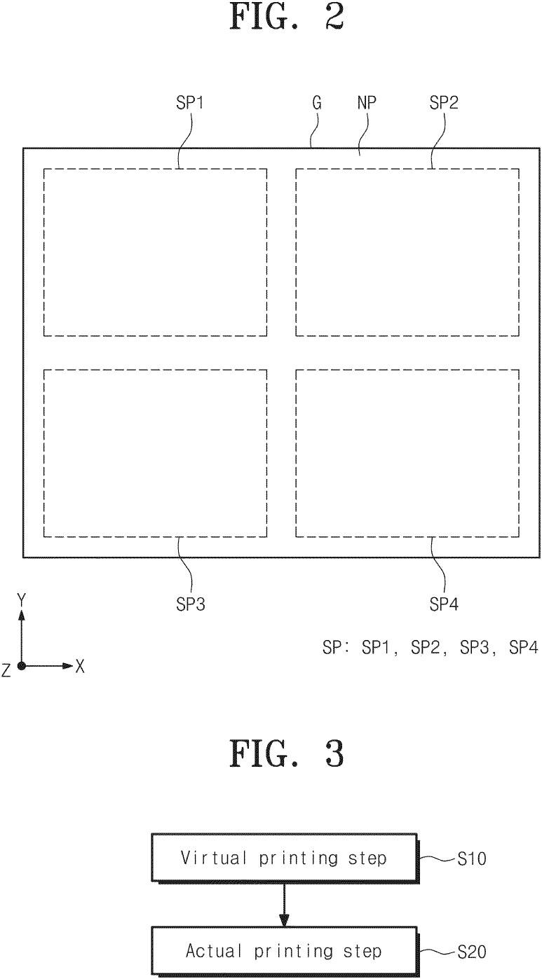

Hereinafter, a printing method according to an exemplary embodiment of the present invention will be described. FIG. 3 is a flowchart illustrating a printing method according to an exemplary embodiment of the present invention.

Referring to FIG. 3, the printing method according to an exemplary embodiment of the present invention may include a virtual printing step (S10) and an actual printing step (S20). The virtual printing step (S10) may be a step for determining print paths to be applied when ejecting the ink to the substrate G through simulation, that is, virtual printing. The actual printing step (S20) may be a step of performing actual printing by ejecting the ink to the substrate G based on the print paths determined in the virtual printing step (S20). In the printing method according to an exemplary embodiment of the present invention, the virtual printing step (S10) and the actual printing step (S20) may be sequentially performed. After the virtual printing step (S10) is performed, the actual printing step (S20) may be performed.

The actual printing step (S20) is performed after the virtual printing step (S10), and for convenience of description, the actual printing step (S20) will be first described below.

In the actual printing step (S20), a printing process may be performed on the substrate G disposed on the stage 110. The printing process may be performed by an ejecting operation and a path changing operation. The ejecting operation may be an operation in which the substrate G moves and passes through the lower region of the head unit 140 located at a predetermined position at a predetermined rate, but at least one of the nozzles 143 of the head unit 140 ejects the ink to the substrate G passing through the lower region of the head unit 140. The path changing operation may be an operation of moving the position of the head unit 140 along the first direction X in order to change the print path of the head unit 140 performing the ejecting operation.

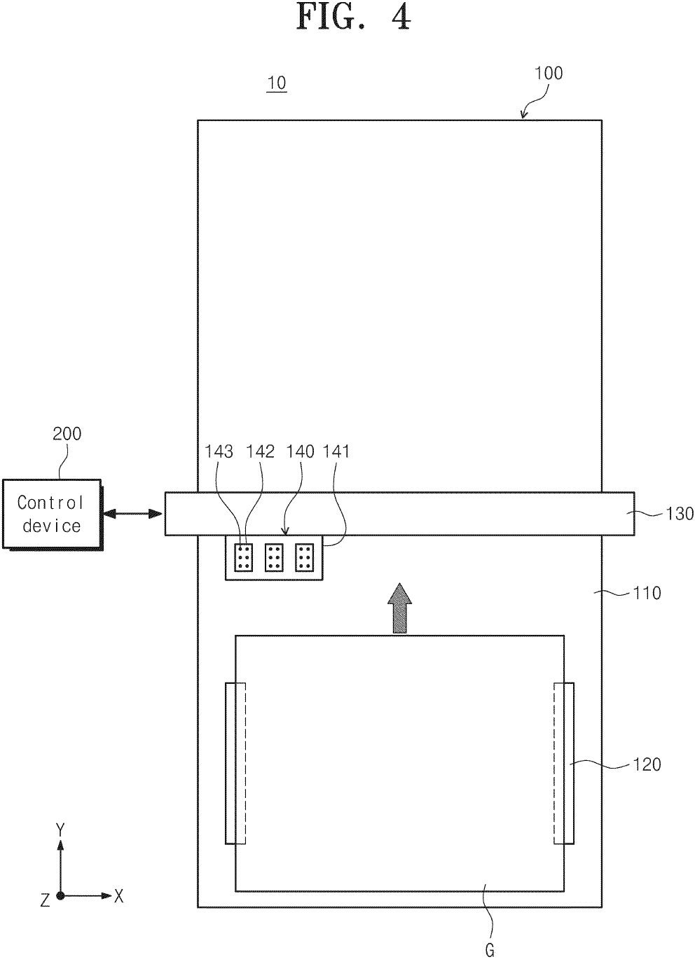

FIG. 4 is a diagram schematically illustrating an appearance of an inkjet device that performs an ejecting operation.

Referring to FIG. 4, the head unit 140 may be located at a first position. The substrate G may pass through the lower region of the head unit 140 located at the first position at a constant velocity. The moving unit 120 may move the substrate G at a constant velocity. The moving unit 120 may move the substrate G along the second direction Y. The nozzles 143 of the head unit 140 may eject the ink to the substrate G passing through the lower region of the head unit 140. In this case, a print path to be applied when the ink is ejected to the substrate G may be referred to as a first path.

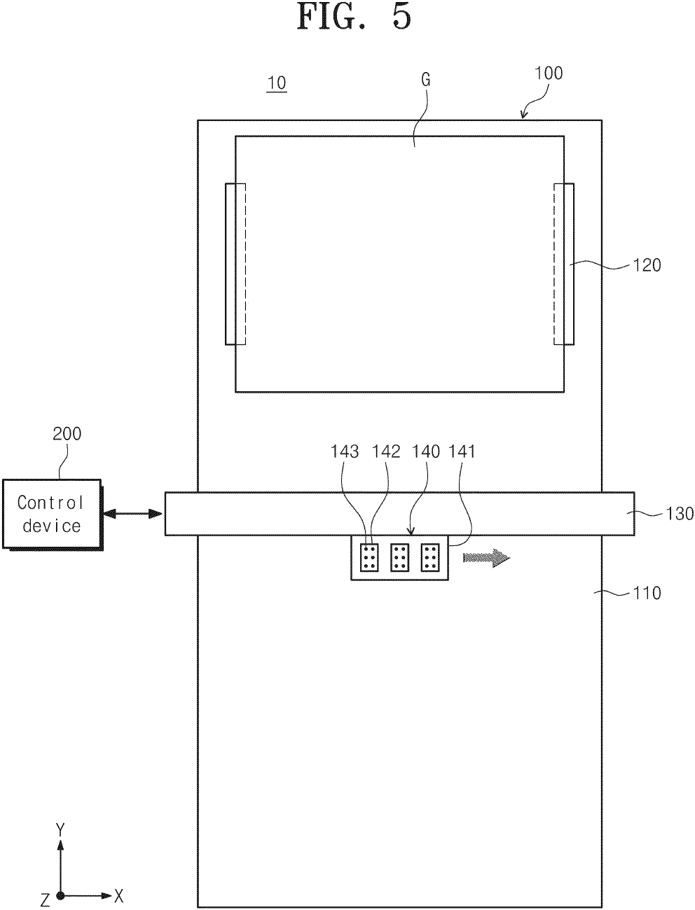

FIG. 5 is a diagram schematically illustrating an appearance of the inkjet device that performs a path changing operation.

Referring to FIG. 5, the position of the head unit 140 may be changed. When the position of the head unit 140 is changed, a print path to be applied in an ejecting operation performed later may be changed. For example, the position of the head unit 140 may be changed in the first direction X along the gantry unit 130. For example, the head unit 140 may move to a second position that is different from the first position described above.

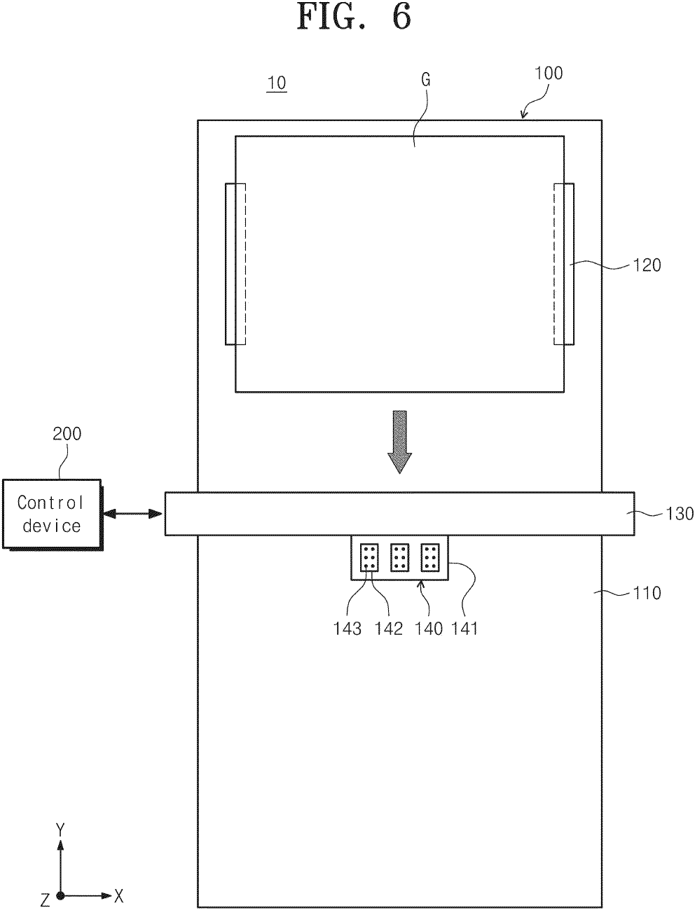

FIG. 6 is a diagram schematically illustrating the inkjet device that performs the ejecting operation again after the path changing operation of FIG. 5.

Referring to FIG. 6, the changing of the position of the head unit 140 from the first position to the second position may be completed through the path changing operation described above. That is, the head unit 140 may be located at the second position. The substrate G may pass through the lower region of the head unit 140 located at the second position at a constant velocity. The moving unit 120 may move the substrate G at a constant velocity. The moving unit 120 may move the substrate G along the second direction Y. The nozzles 143 of the head unit 140 may eject the ink to the substrate G passing through the lower region of the head unit 140. At this time, a print path to be applied when the ink is ejected to the substrate G may be referred to as a second path.

The actual printing step (S20) may be performed by repeating the ejecting operation and the path changing operation described above. When the actual printing step (S20) is completed, a target printing condition for the substrate G may be satisfied. The target printing condition may be a target volume for each of the aforementioned print units, more specifically, each of the auxiliary print units. In addition, the target volume for each of the print units may be the same as or different from each other. The target volumes of some of the print units may be the same as each other, and the target volumes of some of the print units may be different from each other.

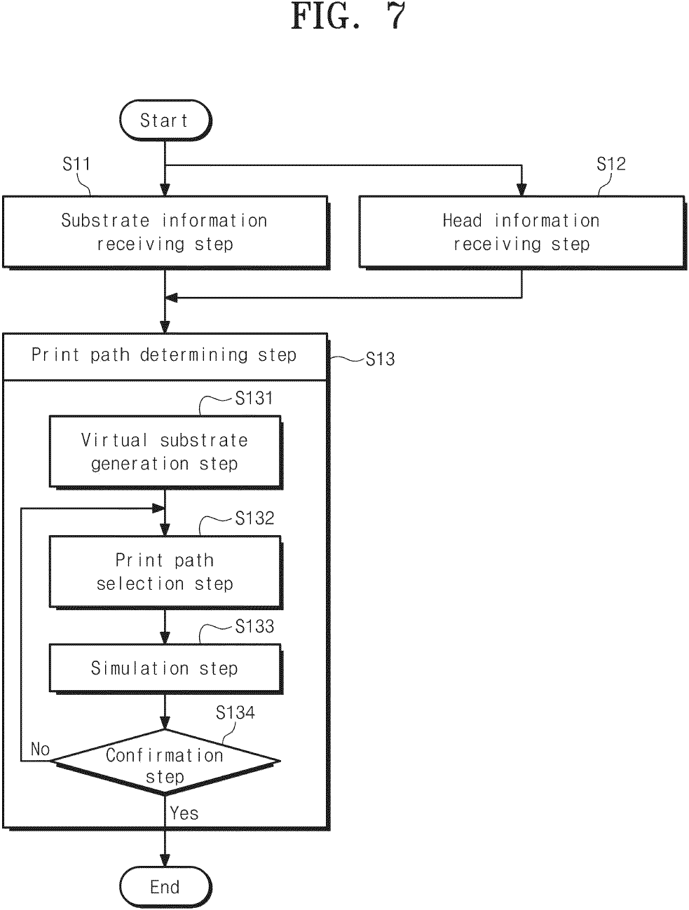

Hereinafter, the virtual printing step (S10) according to an exemplary embodiment of the present invention will be described in detail. FIG. 7 is a flowchart illustrating the virtual printing step of FIG. 3.

Referring to FIG. 7, the virtual printing step (S10) may be a simulation algorithm implemented through a program stored in the control device 200, unlike the actual printing step (S20), which is performed by actually ejecting the ink to the substrate G, which is an actual substrate. In the virtual printing step (S10), print paths that may be applied in the actual printing step (S20) may be determined. In the virtual printing step (S10), the smallest number of print paths that satisfy the target printing condition for the above-described substrate G may be derived.

The virtual printing step (S10) may include a substrate information receiving step (S11), a head information receiving step (S12), and a print path determining step (S13).

In the substrate information receiving step (S11), information on the substrate G to be treated may be received. An operator may input the information on the substrate G to be treated to the control device 200. The substrate information as the information on the substrate G may include a type of the substrate G, a size of the substrate G, a position of the print unit formed on the substrate G and from which the ink is ejected, a position of an auxiliary print unit included in the print unit, a target ejection ink amount (target volume) required for the print unit, an element (which of R, G, or B should be included) to be included in the sub print unit, position information of the above-described print region SP and non-print region NP, and the like.

The head information receiving step (S12) may include information about the heads 142 included in the head unit 140, more particularly, the nozzles 143 formed on the heads 142. As described above, the head unit 140 may have a plurality of nozzles 143. Each nozzle 143 may have slightly different quality due to a shape, an installation position, or various other reasons. For example, each of the nozzles 143 may be different from each other in impact reproducibility (when ink is ejected several times, a position at which the ejected ink is impacted is the same), uniformity of the amount of ink to be ejected, and the like. In addition, some of the nozzles of the head 142 may be usable, and others may be unusable because the impact reproducibility and the uniformity of the amount of ink to be ejected are very poor or the ejection is not performed properly. In addition, the amount (ejection volume) of ink to be ejected from the nozzles 143 may be different from each other.

In the head information receiving step (S12), head information, which may be information about these nozzles 143, may be received. The head information may be input to the control device 200 by an operator.

The head information may include nozzle grade information about a grade of each of the nozzles 143 based on at least one of the impact reproducibility of the nozzles 143 of the head 142, the number of times of use of each of the nozzles 143, and the uniformity of the amount of ink to be ejected from each of the nozzles 143. As the impact reproducibility of the nozzles 143 and the uniformity of the amount of ink to be ejected are excellent and the number of times of use of the nozzles 143 is decreased, the nozzle grade may be classified into a high grade.

In addition, the head information may include position information of usable nozzles among the nozzles 143 and nozzle specification information on the amount of ink to be ejected from each of the nozzles 143.

The head information receiving step (S12) may be performed simultaneously with the substrate information receiving step (S11). Alternatively, the head information receiving step (S12) may also be performed after the substrate information receiving step (S11) or may be performed before the substrate information receiving step (S11).

In the print path determining step (S13), the smallest number of print paths satisfying the target printing condition for the substrate G to be treated in the actual printing step (S10) may be determined.

The print path determining step (S13) may include a virtual substrate generation step (S131), a print path selection step (S132), a simulation step (S133), and a confirmation step (S134).

In the virtual substrate generation step (S131), a virtual substrate reflecting target printing conditions may be generated based on the substrate information on the substrate G to be actually treated which is received in the substrate information receiving step (S11) described above. The generated virtual substrate may be a virtual substrate IG on a program on which virtual printing is performed in the simulation step (S133) to be described below.

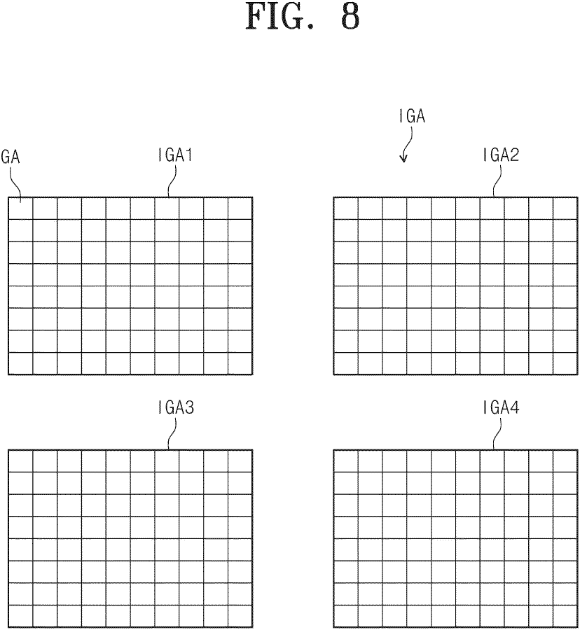

FIG. 8 is a diagram illustrating an example of the virtual substrate generated in the virtual substrate generation step of FIG. 7. FIG. 8 shows an example of a virtual substrate IGA according to a first exemplary embodiment among the virtual substrates IG based on the substrate information on the substrate G of FIG. 2.

Referring to FIG. 8, the substrate G of FIG. 2 includes a plurality of print regions SP1, SP2, SP3, and SP4, and in the virtual substrate generation step (S131), a plurality of virtual substrates IGA1, IGA2, IGA3, and IGA4 corresponding to the plurality of print regions SP1, SP2, SP3, and SP4 may be generated. Each of the virtual substrates IGA1, IGA2, IGA3, and IGA4 may be expressed in the form of a grid, and the print regions SP1, SP2, SP3, and SP4 may be expressed as a plurality of grids GA. Each grid may correspond to the above-described print unit. For example, each grid may correspond to the above-described auxiliary print unit.

FIG. 9 is a diagram illustrating another example of the virtual substrate generated in the virtual substrate generation step of FIG. 7. FIG. 9 shows an example of a virtual substrate IGB according to a second exemplary embodiment among the virtual substrates IG based on the substrate information on the substrate G.

In the above-described example, the generating of the plurality of virtual substrates IGA1, IGA2, IGA3, and IGA4 corresponding to the plurality of print regions SP1, SP2, SP3, and SP4 in the virtual substrate generation step (S131) has been described as an example, but unlike this, a virtual substrate may also be generated. The virtual substrate IGB may be represented by a plurality of grids GB. The grid GB may include a print grid SGB and a non-print grid NGB.

For example, in the virtual substrate generation step (S131), the virtual substrate IGB corresponding to the substrate G is expressed in a grid form, and the print regions SP1, SP2, SP3, and SP4 may be expressed as print grids SGB, and the non-print region NP may be expressed as a non-print grid NGB. The print grids SGB and the non-print grid NGB may be distinguished in various manners, but, for example, the print grids SGB and the non-print grid NGB may be distinguished from each other by varying a shade. As illustrated in FIG. 9, the print grids SGB may be collected to implement a first virtual print region IP1 to a fourth virtual print region IP4 corresponding to the first print region SP1 to the fourth print region SP4, respectively.

FIG. 10 is a diagram schematically illustrating another example of the actual substrate, which is the object to be treated, on which the inkjet system of FIG. 1 performs a printing process. As in an example of a substrate G′ illustrated in FIG. 10, print regions SP1ʹ, SP2ʹ, SP3ʹ, and SP4ʹ may have different shapes depending on the substrate Gʹ. For example, the first print region SP1ʹ and the second print region SP2ʹ may have the same shape as each other, the third print region SP3ʹ may have a shape inclined with respect to the second direction Y (e.g., a parallelogram shape), and the fourth print region SP4ʹ may have a rectangular shape having a length shorter in the second direction Y than the first print region SP1ʹ and the second print region SP2ʹ.

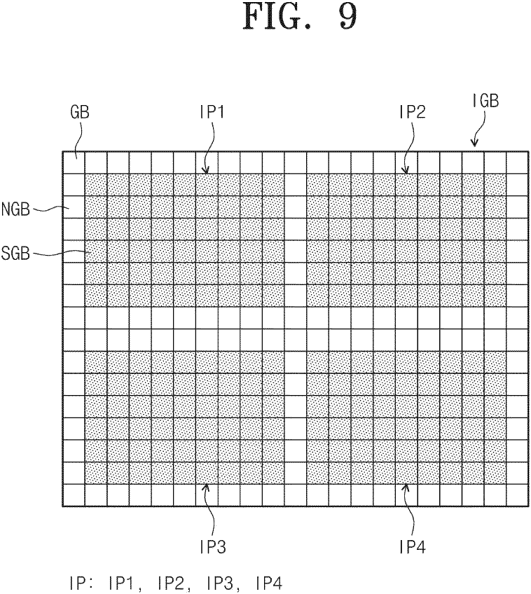

FIG. 11 is a diagram illustrating another example of the virtual substrate generated in the virtual substrate generation step of FIG. 7. FIG. 11 shows an example of a virtual substrate IGBʹ according to a third exemplary embodiment among the virtual substrates IG based on the substrate information on the substrate Gʹ.

As illustrated in FIG. 11, even if the shapes of the print regions SP1ʹ, SP2ʹ, SP3ʹ, and SP4ʹ are changed, the virtual substrate IGBʹ may express virtual print regions IP1ʹ, IP2ʹ, IP3ʹ, and IP4ʹ through grids GBʹ including a print grid SGBʹ and a non-print grid NGBʹ.

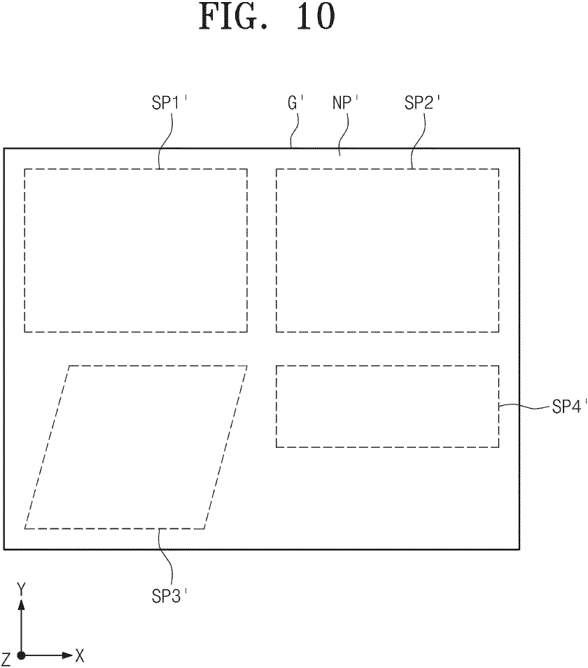

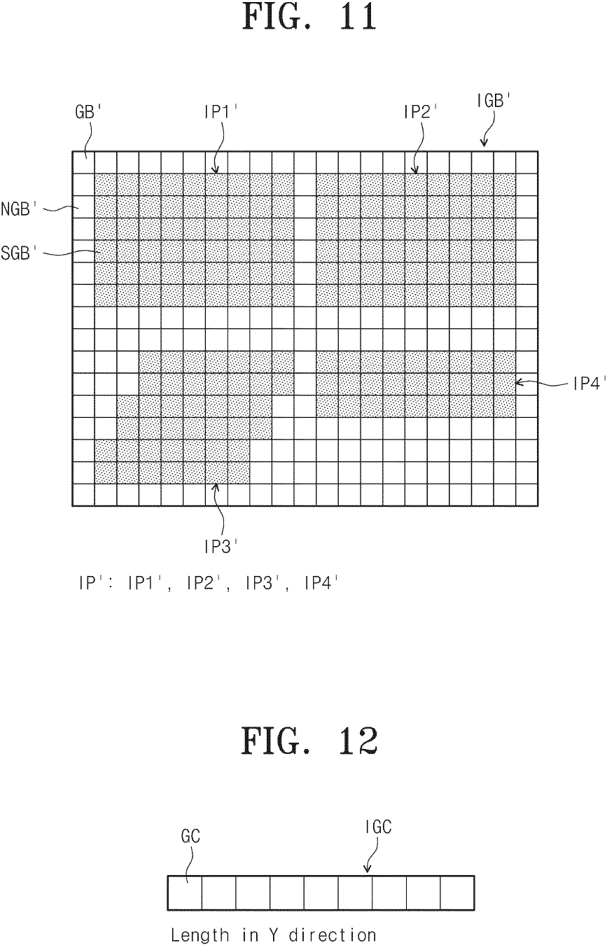

FIG. 12 is a diagram illustrating another example of the virtual substrate generated in the virtual substrate generation step of FIG. 7. FIG. 12 shows an example of a virtual substrate IGC according to a fourth exemplary embodiment among the virtual substrates IG.

As illustrated in FIG. 12, when information on the print region SP, which may be included in the information on the substrate G, satisfies a specific condition, the virtual substrate IGC may be expressed in a simplified manner. For example, when the arrangement of print units located at the outermost side among print units constituting the print region SP is parallel to the first direction X and the second direction Y and/or target ink volumes between print units of the substrate G arranged along the second direction Y are the same as each other, as illustrated in FIG. 12, the virtual substrate IGB may be expressed by grids GC arranged in the first direction X and lengths in the second direction Y (Y direction). That is, in the case of a rectangular print region SP arranged horizontally or vertically to the printing direction, the movement direction during the ejecting operation for the substrate G is stored as data in the second direction Y length, and only the first direction X is expressed as an array or list type data structure. Such an expression method not only reduces a memory usage, but also simplifies a process of matching the nozzles 143 to correspond to the print region SP, thereby improving an algorithm speed (that is a speed at which the virtual printing step (S10) is performed).

In addition, when the arrangement of the print units located at the outermost side among the print units is not parallel to the first direction X or the second direction Y, as in the previous example, the virtual substrates IGA and IGB may be generated by expressing only the grids GA and GB.

The virtual substrate IG may have a different appearance from the actual substrate G depending on a form to be expressed, but since the virtual substrate IG is generated based on substrate information of the actual substrate G, it can be seen that the simulation result for the virtual substrate IG is substantially the same as the actual printing result for the actual substrate G.

Referring back to FIG. 7, in the print path selection step (S132) according to an exemplary embodiment of the present invention, print paths for performing virtual printing for the virtual substrates IGA, IGB, and IGB may be selected. The position of the head unit 140 may be variously modified with a minimum moving distance interval. For example, the position of the head unit 140 may be changed to a first position, a second position, a third position, ...., and an n-th position. Correspondingly, the print path may exist as a first path, a second path, a third path, ...., and an n-th path. A plurality of print paths may exist depending on the position at which the head unit 140 may be changed. Information on print paths that may exist according to a changeable position of the head unit 140 may be stored in advance in the control device 200.

When the printing is performed on the substrate G, a print path set (also called a “swath set”) consisting of print paths for satisfying a specific target printing condition may variously exist. According to an exemplary embodiment of the present invention, in the print path determining step (S13), a print path set consisting of the smallest number of print paths is derived from various print path sets to apply the corresponding print path set to the actual printing step (S20). In the print path selection step (S132), a print path with the highest priority is searched and selected from the print paths.

In the simulation step (S133), virtual printing may be performed by applying the print path selected in the print path selection step (S132) to the virtual substrate IG.

In the confirmation step (S134), it may be determined whether a target printing condition has been satisfied as a result of the virtual printing performed in the simulation step (S133). When the target printing condition is satisfied, the print path determining step (S13) is terminated, and the printing process on the substrate G is performed by applying the print path set derived in the print path determining step (S13) (that is, the print paths selected until the target printing condition is satisfied) to the actual printing step (S20).

If the target printing condition is not satisfied in the confirmation step (S134), the print path selection step (S132) is additionally performed by the target printing condition, and in the additionally performed print path selection step (S 132), a print path with the second priority is searched and selected.

This process is repeatedly performed until the target printing condition is satisfied.

That is, in the print path determining step (S13) of the present invention, the print path is sequentially selected in the order of priority from the print path with a high priority to derive a print path set consisting of the smallest number of print paths satisfying the target printing condition for the virtual substrate IG.

Hereinafter, an example of a print path having a higher priority when the print path is selected in the print path selection step (S132) will be described.

FIG. 13 is a diagram illustrating an example of print paths that may be applied during a printing process for the virtual substrate in relation to the print path selection step of FIG. 7.

FIG. 13 shows an example of performing the printing on the virtual substrate IG by sequentially moving the position of the head unit 140 by a predetermined distance without considering the priority of the print paths. As illustrated in FIG. 13, in order to complete the printing process for the virtual substrate IG, the print path set may include a first print path SW1 to a tenth print path SW10. Each of the print paths SW1 to SW10 may be implemented as the position of the head unit 140 in the first direction X is changed. A print region of the virtual substrate IG in which each of the print paths SW1 to SW10 performs the printing may partially overlap. This is because, rather than completing printing for a specific region by one ink ejection, it is advantageous in minimizing a decrease in print uniformity due to the quality deviation of the nozzles 143 by completing the ink ejection several times.

Meanwhile, the print region of the virtual substrate IG may include edge portions A and a central portion B arranged along the first direction X. The central portion B has many chances of printing to be performed as illustrated in FIG. 13. For example, the first print path SW1 to the tenth print path SW10 may all contribute to printing on the central portion B. That is, in the case of the central portion B, although there are many chances of printing to be performed, a large number of print paths are arranged, so that the printing efficiency may be reduced.

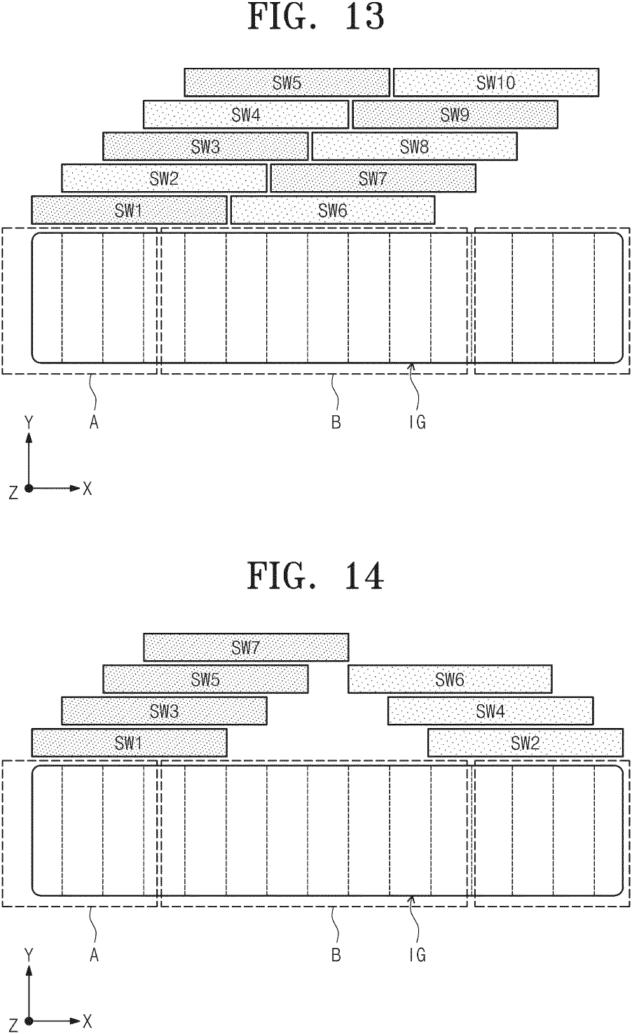

FIG. 14 is a diagram illustrating another example of print paths that may be applied during a printing process for the virtual substrate in relation to the print path selection step of FIG. 7.

FIG. 14 shows an example of performing printing on the virtual substrate IG in consideration of the priority of print paths. As illustrated in FIG. 14, in order to complete the printing process for the virtual substrate IG, it may be sufficient only that the print path set includes a first print path SW1 to a seventh print path SW7. Each of the print paths SW1 to SW7 may be implemented as the position of the head unit 140 in the first direction X is changed.

As described above, the print region of the virtual substrate IG may include edge portions A and a central portion B arranged along the first direction X, and the central portion B may have many chances of printing to be performed, while the edge portions A may have relatively few chances of printing to be performed.

Accordingly, in the print path selection step (S132) according to an exemplary embodiment of the present invention, a print path for performing printing on the edge portion A of the virtual substrate IG having a relatively low chance to be printed may be preferentially selected.

That is, in selecting a print path for performing virtual printing on the virtual substrate IG in the print path selection step (S132), a print path for performing virtual printing on the edge portion A of the virtual substrate IG may be preferentially selected.

For example, in the print path selection step (S132), the first print path SW1, the second print path SW2, the third print path SW3, the fourth print path SW4, the fifth print path SW5, the sixth print path SW6, and the seventh print path SW7 illustrated in FIG. 14 may be sequentially selected.

When the virtual substrate IG is viewed from the plane, the first print path SW1 and the second print path SW2 may be the same distance from the central portion B of the virtual substrate IG, for example, the same distance from a virtual line parallel to the second direction Y and passing through the center of the substrate G.

The priority between the first print path SW1 and the second print path SW2 may be determined by other factors described below, in addition to the degree of the distance from the central portion of the substrate G.

Similarly, the third print path SW3 and the fourth print path SW4 may have the same distance from the central portion B of the virtual substrate IG. In addition, the fifth print path SW5 and the sixth print path SW6 may also have the same distance from the central portion B of the virtual substrate IG. The priority between the third print path SW3 and the fourth print path SW4, and the priority of the fifth print path SW5 and the sixth print path SW6 may also be determined by other factors to be described below.

FIGS. 15 to 17 are diagrams illustrating examples of weight functions W(x) that may be applied in relation to the print path selection step of FIG. 7.

As in the example above, when it is desired to preferentially select a print path passing through the edge portion A than the central portion B of the virtual substrate IG, a weight function W(x) as shown in FIG. 15 is applied. For example, in FIG. 15, a weight function W(x) in which a weight is changed according to a distance from the center of the virtual substrate IG is illustrated. In this case, as the distance from the center of the virtual substrate IG increases, the weight to be applied when selecting the print path increases, so that the print path farther than the central portion B of the virtual substrate IG is preferentially selected.

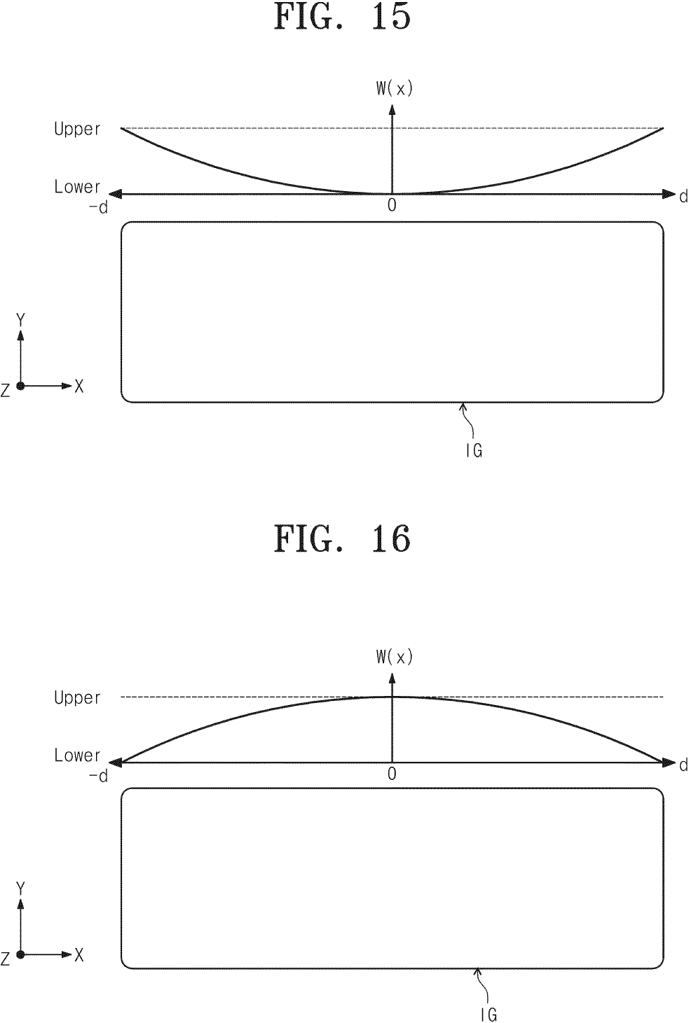

In the above-described example, it has been described as an example that the print path passing through the edge portion A is selected preferentially to the central portion B of the virtual substrate IG, but if necessary, it may be necessary to select the print path passing through the central portion B preferentially to the edge portion A of the virtual substrate IG. In this case, as illustrated in FIG. 16, as the weight function W(x) approaches the center of the virtual substrate IG, the weight to be applied when the print path is selected increases, so that a print path closer to the central portion B of the virtual substrate IG is preferentially selected.

In addition, if necessary, as illustrated in FIG. 17, the virtual substrate IG may include a first region C and a second region D different from the first region C. A boundary between the first region C and the second region D may be an eccentric position with respect to the center of the virtual substrate IG. The required ink volumes may be different from each other in the first region C and the second region D. For example, when it is necessary to eject relatively less ink into the second region D than the first region C, a print path may be selected by applying a weight function W(x) that is directed toward the second region D. In this case, in a weight function W(x) graph, since the area of a portion corresponding to the second region D is smaller than the area of a portion corresponding to the first region C, relatively more print paths passing through the first region C may be selected.

Hereinafter, other factors will be described, except for the factor related to the print path and the distance from the central portion of the substrate G, among the factors determining the priority of the print path.

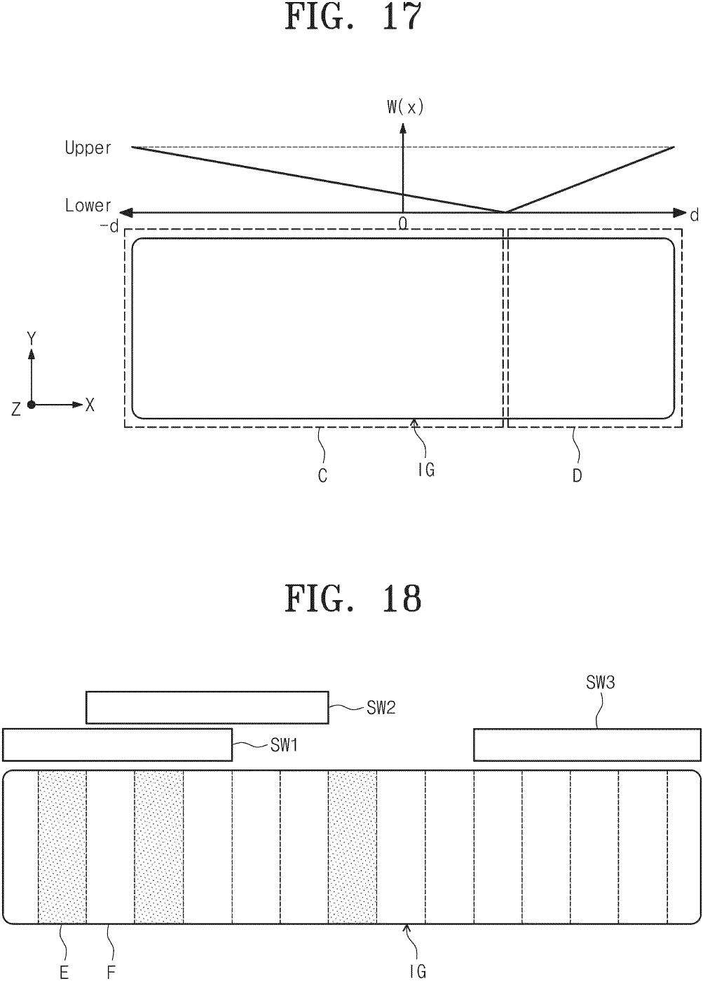

FIG. 18 is a diagram for describing selecting a print path in consideration of a region to which the printing is applied or a region in which the printing is completed, in relation to the print path selection step of FIG. 7.

Referring to FIG. 18, in the print path selection step (S132), a print path that is less overlapped with the region to which the printing is applied, more specifically, the region to which the virtual printing is applied or the region in which the virtual printing is completed in the simulation step (S133), may be preferentially selected. For example, as illustrated in FIG. 18, when the simulation step (S133) is performed at least one time or more, the virtual printing result may be partially applied to the virtual substrate IG. When a region in which printing is performed at least once or a region in which printing is completed is referred to as a print application region E and a region in which the printing is not performed is referred to as a non-print region F, a print path less overlapping with the print application region E may be preferentially selected. For example, when the print application region E is described as an example that the printing is completed, the first print path SW1 may have the efficiency of about 60%, the second print path SW2 may have the efficiency of about 80%, and the third print path SW3 may have the efficiency of about 100%. In this case, the second print path SW2 may be selected preferentially to the first print path SW1, and the third print path SW3 may be selected preferentially to the second print path SW2. That is, by preferentially selecting the print path that less overlaps with the print application region E, it is possible to further reduce the number of print paths satisfying the target printing condition.

FIG. 19 is a diagram for describing selecting a print path by additionally considering the number of usable nozzles of a head, in addition to the consideration of the region to which the printing is applied or the region in which the printing is completed, in relation to the print path selection step of FIG. 7.

Referring to FIG. 19, as described above, the head information input to the control device 200 may include not only nozzle information about the grade of each of the nozzles 143 based on at least one of impact reproducibility of each of the nozzles 143 of the head 142, the number of times of use of each of the nozzles 143, and uniformity of the amount of ink to be ejected from each of the nozzles 143, but also position information of usable nozzles 143 of the head 142 and nozzle specification information about the amount of ink to be ejected from each of the nozzles 143.

Some of the nozzles 143 of the head 142 may be nozzles 143 that may have very low quality of ink ejection or cannot eject ink in some cases. For example, the head unit 140 may include unusable nozzles NN and usable nozzles PN. When the position of the usable nozzles PN of the head unit 140 is additionally considered, the result may vary when determining the priority of the print path in consideration of the print application region E and the print non-application region F.

For example, considering the number and positions of the unusable nozzles NN of the head unit 140 as shown in FIG. 19, the first print path SW1 and the third print path SW3 have the efficiency of 60% and the second print path SW2 has the efficiency of 40%. In this case, the first print path SW1 and the third print path SW3 may be selected preferentially to the second print path SW2.

In addition to the factors affecting the priority of the print path selection as described above, the nozzle grade information may be further considered. For example, when the same priority print path occurs even after considering all of the above factors, the nozzle grade information may be additionally considered. For example, when the same priority print path occurs, a print path including more nozzles of a high grade may be preferentially selected from the print paths. As a print path including more nozzles of a higher grade, for example, a print path having a higher score may be preferentially selected by assigning a score for each grade of the nozzle, and summing all scores corresponding to grades of each nozzle participating in printing.

In the example, when the same priority print path occurs, the nozzle grade information is additionally considered as an example, but the present invention is not limited thereto, and the nozzle grade information may also be considered together with the priority consideration factors described above.

Hereinafter, a specific example in which the simulation step (S133) is performed will be described. Hereinafter, an example in which the simulation step (S133) is performed using the virtual substrate IGC according to the fourth exemplary embodiment among the above-described virtual substrates IG will be described.

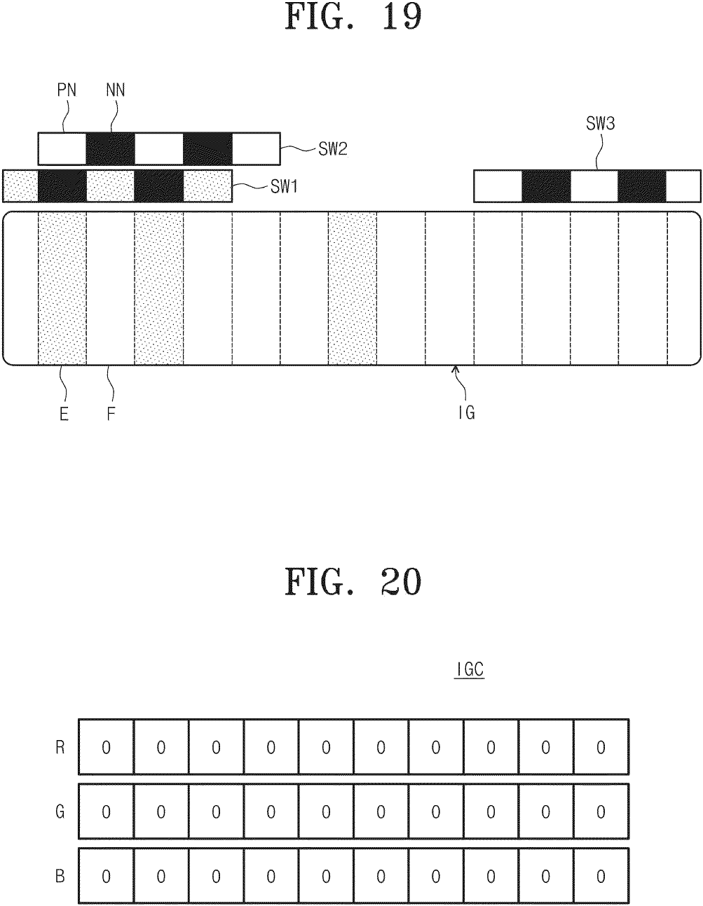

FIG. 20 is a diagram illustrating an example of a virtual substrate, before a simulation step is performed.

As shown in FIG. 20, in the virtual substrate generation step (S131), a virtual substrate IGC corresponding to each color of ink to be used may be generated. That is, a virtual substrate IGC may be generated in response to each auxiliary print unit. Each virtual substrate IGC may have an initial value set to 0. That is, a target ejection ink amount or the number of target ejection ink droplets may not be applied to the virtual substrate IGC.

FIG. 21 is a diagram illustrating an appearance of the virtual substrate of FIG. 20, after the simulation step is performed. As illustrated in FIG. 21, when virtual printing is performed on the virtual substrate IGC, the virtual printing result may be reflected to the virtual substrate IGC in an up-counting manner. For example, after the virtual printing result to which any one of the print paths is applied is reflected to the virtual substrate IGC, it is confirmed whether the reflected virtual printing result satisfies the target printing condition in the confirmation step (S134). Whether the target printing condition is satisfied may be determined by whether the up-counted number meets the target printing condition. When the target printing condition is satisfied, it is determined that the print path set has been completed and then the virtual printing step (S10) is terminated. When the target printing condition is not satisfied, it is determined that the print path set is not completed and then the print path selection step (S132) is performed again.

In the above-described example, it has been described that the initial value of the virtual substrate IGC is 0 and the virtual printing result is reflected to the virtual substrate IGC in the up-counting manner, but the present invention is not limited thereto.

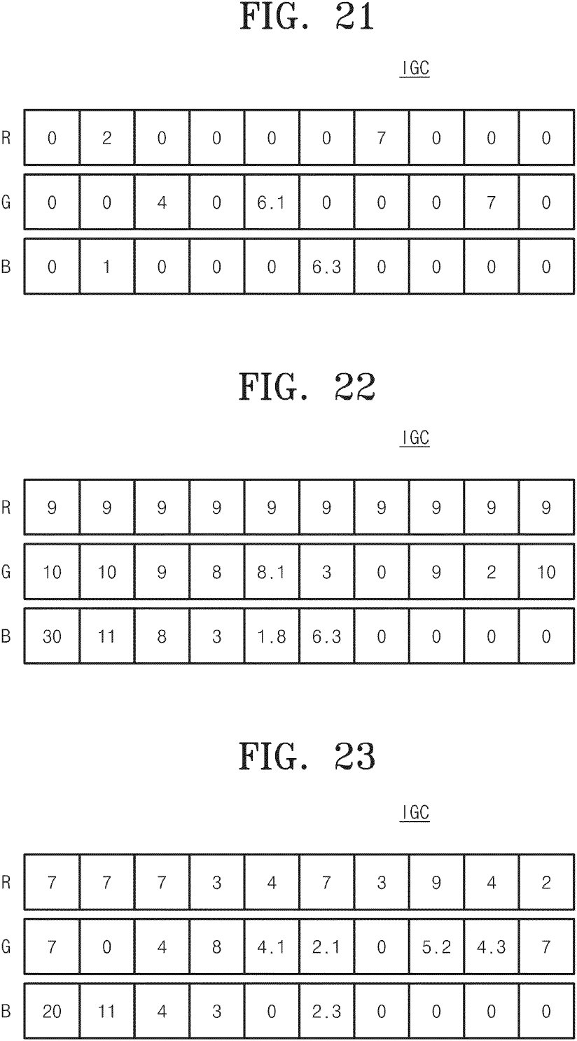

For example, as illustrated in FIG. 22, a virtual substrate IGC in which the target printing condition previously input to the control device 200 is reflected may be generated in the virtual substrate generation step S131. In this case, a target ejection ink amount or the number of target ejection ink droplets may be applied to the virtual substrate IGC.

FIG. 23 is a diagram illustrating an appearance of the virtual substrate of FIG. 22, after the simulation step is performed. As illustrated in FIG. 23, when virtual printing is performed on the virtual substrate IGC, the virtual printing result may be reflected to the virtual substrate IGC in a down-counting manner. For example, after the virtual printing result to which any one of the print paths is applied is reflected on the virtual substrate IGC, it is confirmed whether the reflected virtual printing result satisfies the target printing condition in the confirmation step (S134). Whether the target printing condition is satisfied may be determined by whether the down-counted number has reached 0. When the target printing condition is satisfied, it is determined that the print path set has been completed and then the virtual printing step (S10) is terminated. When the target printing condition is not satisfied, it is determined that the print path set is not completed and then the print path selection step (S132) is performed again.

When the actual printing step (S20) is performed using the print path set determined in the virtual printing step (S10), the number of print paths required to satisfy the printing conditions for the actual substrate G may be minimized, thereby shortening more reliably the time required to perform the printing process of the actual substrate G. In addition, since the print path is selected in consideration of the nozzle grade information of the nozzle 143 when the print path is selected, the printing quality of the actual substrate G may also be improved. In addition, the printing result may be predicted through the virtual substrate printing step (S10). Accordingly, when it is determined that the printing quality is not as good as expected or it takes a lot of printing time, the user may take measures other than the above-described method, so that there is an advantage of more efficiently operating the printing process. In addition, the method of determining the print paths and the printing method described above may be implemented through a program stored in a recording medium.

The foregoing detailed description illustrates the present invention. Further, the above content shows and describes the exemplary embodiment of the present invention, and the present invention can be used in various other combinations, modifications, and environments. That is, the foregoing content may be modified or corrected within the scope of the concept of the invention disclosed in the present specification, the scope equivalent to that of the disclosure, and/or the scope of the skill or knowledge in the art. The foregoing exemplary embodiment describes the best state for implementing the technical spirit of the present invention, and various changes required in specific application fields and uses of the present invention are possible. Accordingly, the detailed description of the invention above is not intended to limit the invention to the disclosed exemplary embodiment. Further, the accompanying claims should be construed to include other exemplary embodiments as well.

1. A method for determining print paths to be applied when ink is ejected to a substrate, the method comprising:
a substrate information receiving step of receiving substrate information of the substrate;
a head information receiving step of receiving head information of a head that ejects the ink; and
a print path determining step of determining the print paths based on the substrate information and the head information,
wherein in the print path determining step, the smallest number of print paths satisfying a target printing condition for the substrate is determined.

2. The method of claim 1, wherein
the print path determining step comprises
a virtual substrate generation step of generating a virtual substrate reflecting the target printing condition based on the substrate information;
a print path selection step of selecting a print path having a high priority from the print paths;
a simulation step of performing virtual printing by applying the selected print path to the virtual substrate; and
a confirmation step of confirming whether the target printing condition has been satisfied, after the simulation step.

3. The method of claim 2, wherein
the substrate information includes information on a position of a print unit in which the ink is ejected to the substrate and a target ejection ink amount required for the print unit, and
in the print path selection step, a print path far from a central portion of a print region is preferentially selected from the print paths, wherein the print region consists of the print units.

4. The method of claim 3, wherein
in the print path determining step,
a print path which is less overlapped with a region to which the virtual printing is applied or a region in which the virtual printing is completed is preferentially selected from the print paths.

5. The method of claim 4, wherein
the head information includes nozzle grade information about a grade of each of the nozzles based on at least one of impact reproducibility of each of the nozzles of the head, the number of times of use of each of the nozzles, and uniformity of the amount of ink to be ejected from each of the nozzles; or
position information of usable nozzles among the nozzles of the head and nozzle specification information on the amount of the ink to be ejected from each of the nozzles.

6. The method of claim 5, wherein
in the print path determining step,
a print path including more nozzles of a high grade is preferentially selecting from the print paths.

7. The method of claim 5, wherein
in the print path determining step,
a print path including more usable nozzles overlapped with a region required for printing is preferentially selecting from the print paths.

8. The method of claim 2, wherein
the virtual substrate is expressed in the form of a grid.

9. The method of claim 8, wherein
in the virtual substrate generation step, the virtual substrate is generated as many as the number of colors of the ink.

10. The method of claim 8, wherein
in the virtual substrate generation step, a target ejection ink amount or the number of target ejection ink droplets are not applied to the virtual substrate, and
in the simulation step, the virtual printing on the virtual substrate is performed in an up-counting manner.

11. The method of claim 8, wherein
in the virtual substrate generation step, the target ejection ink amount or the number of target ejection ink droplets are applied to the virtual substrate, and
in the simulation step, the virtual printing on the virtual substrate is performed in a down-counting manner.

12. A non-transitory computer readable medium storing a program, which when executed by a computer, causes the computer to perform the method of claim 1.

13. A printing method for ejecting ink to a substrate using a head, the printing method comprising:
a virtual printing step for determining print paths to be applied when ink is ejected the substrate; and
an actual printing step of ejecting the ink to the substrate based on the print paths determined in the virtual printing step,
wherein in the virtual printing step, the smallest number of print paths satisfying a target printing condition for the substrate is determined.

14. The printing method of claim 13, wherein
the virtual printing step comprises
a virtual substrate generation step of generating a virtual substrate reflecting the target printing condition based on substrate information of the substrate, wherein the substrate information includes information about a position of a print unit in which the ink is ejected to the substrate and a target ejection ink amount required for the print unit;
a print path selection step of selecting a print path having a high priority from the print paths;
a simulation step of performing virtual printing by applying the selected print path to the virtual substrate; and
a confirmation step of confirming whether the target printing condition has been satisfied, after the simulation step.

15. The printing method of claim 14, wherein
when the target printing condition is not satisfied in the confirmation step, the print path selection step is additionally performed, and
when the target printing condition is satisfied in the confirmation step, the actual printing step is performed using selected print paths until the target printing condition is satisfied.

16. The printing method of claim 15, wherein
in the print path selection step, the print path is selected according to the priority based on at least one of
a) a position of a print path;
b) the number of nozzles of the head passing through a region required for printing; and
c) a grade of the nozzle.

17. The printing method of claim 16, wherein
with respect to a) above, the priority of the print path which is far from the central region of the print region required for printing of the substrate is higher among the print paths.

18. The printing method of claim 16, wherein
with respect to b) above, the priority of the print path which has a large number of nozzles passing through the region required for printing is higher among the print paths.

19. The printing method of claim 16, wherein
with respect to c) above, the grade of the nozzle is determined based on reproducibility of the ink impact position of the nozzles, the number of times of use of the nozzles, uniformity of the amount of ink to be ejected from the nozzles, and the amount of ink to be ejected from the nozzles.

20. The printing method of claim 13, wherein
the virtual substrate is expressed in the form of a grid, but
when a moving direction of the substrate is referred to as a second direction and a moving direction of the head is referred to as a first direction,
when the arrangement of the print units located at the outermost side among the print units is parallel to the first direction and the second direction, the virtual substrate is expressed by grids arranged in the first direction and lengths in the second direction, and
when the arrangement of the print units located at the outermost side among the print units is not parallel to the first direction or the second direction, the virtual substrate is expressed only by the grids.
